(19) United States
(12) Patent Application Publication
(10) Pub. No.: US 2015/0259097 A1
(43) Pub. Date: Sep. 17, 2015

(54) MODULAR STORAGE SYSTEM

(71) Applicant: Doreen O'Hare, Laguna Niguel, CA (US)

(72) Inventor: Doreen O'Hare, Laguna Niguel, CA (US)

(21) Appl. No.: 14/213,568

(22) Filed: Mar. 14, 2014

(51) Int. Cl. B65D 21/08; F16B 7/20; B65D 43/02

(52) U.S. Cl. CPC B65D 21/083; B65D 43/0204; F16B 7/20

(57) ABSTRACT

Disclosed herein are embodiments of a modular storage system. The modular storage system can be made of different components that can be releasably attached to each other. Accordingly, the modular storage system can be variably sized, and a user can stack components to a particular size to fit the user's need. Further, a user can easily remove components to reduce the size of the modular storage system.

### BACKGROUND

1. Field

Disclosed herein are embodiments of a modular storage system having variable size.

2. Description of the Related Art

Many varieties of storage systems exist, employing a variety of configurations. However, such systems and certain components thereof have various limitations and disadvantages.

### SUMMARY

Disclosed herein is a modular storage system, said storage system can comprise a container comprising an outer wall that defines an interior space, a bottom wall connected to the outer wall, and an upper rim that defines a perimeter of an open top, the upper rim having at least one first engagement element, a first connector comprising an outer wall that defines an interior space, a lower rim that defines a perimeter of an open bottom, and an upper rim that defines a perimeter of an open top, both the lower rim and upper rim having at least one second engagement element, a second connector comprising an outer wall that defines an interior space, a lower rim that defines a perimeter of an open bottom, and an upper rim that defines a perimeter of an open top, both the lower rim and upper rim having at least one first engagement element, a lid comprising a top wall and a lower rim, the lower rim having at least one second engagement element, wherein at least one of the second engagement elements of the first connector is configured to releasably engage the first engagement element of the container and at least another of the second engagement elements of the first connector located on an opposite rim of the outer wall is configured to releasably engage the first engagement element of the second connector, and wherein at least one of the first engagement elements of the second connector is configured to releasably engage the second engagement element of the lid and at least another of the first engagement elements of the second connector located on an opposite rim of the outer wall is configured to releasably engage the second engagement element of the first connector.

In some embodiments, the lid can further comprise an outer wall connecting the top wall and the lower rim, the outer wall being shorter than the outer wall of the container. In some embodiments, the first engagement elements can be male engagement elements. In some embodiments, the male engagement elements can extend substantially around the perimeter. In some embodiments, the second engagement elements can be female engagement elements. In some embodiments, the female engagement elements can comprise a plurality of flexible tabs configured to releasably retain the first engagement elements.

In some embodiments, the system can further comprise third and fourth connectors, the third connector configured to have at least one first engagement element on each of a first rim and a second rim of the third connector, and the fourth connector configured to have at least one second engagement element on each of a first rim and a second rim of the fourth connector. In some embodiments, the third and fourth connectors can be configured to releasably be inserted between the container and lid of the storage system.

In some embodiments, the system can be at least 2 feet tall. In some embodiments, all connections between the container, connectors, and lid can be fluid tight seals. In some embodiments, the first and second engagement elements can be configured to be generally engaged along an axis perpendicular to a plane formed by their associated rims.

Further disclosed is a connector piece for use in a modular storage system, said piece can comprise a plurality of connected sidewalls defining a perimeter of the piece, the plurality of sidewalls having an upper rim and lower rim, the upper rim defining a first opening and the lower rim defining a second opening, the first and second opening being connected, and at least one of a male engagement element and a female engagement element on the upper rim and the at least one of the male engagement element and the female engagement element on the lower rim, the engagement elements configured to releasably engage with the other of one of a male engagement element or a female engagement element.

In some embodiments, the perimeter can be generally square shaped. In some embodiments, the engagement elements can be located on opposite walls of the connector piece on both the upper and lower rims. In some embodiments, the engagement elements can be located each wall of the connector piece on both the upper and lower rims. In some embodiments, the at least one of a male engagement element or a female engagement element can be a female engagement element. In some embodiments, the at least one of a male engagement element or a female engagement element can be a male engagement element. In some embodiments, the distance of the connector piece can be at least one foot from the upper rim to the lower rim.

Also disclosed herein is lid component for use in a modular storage system, said lid which can comprise a lower perimeter and a top portion located opposite the lower perimeter and connected with at least one wall to form a closed top, the lower perimeter defining a first opening, wherein the opening extends to the top portion and the at least one wall, at least one female engagement element on the lower perimeter, wherein the at least one female engagement element is configured to releasably engage a male engagement element of a male connector piece, the male connector piece comprising, a plurality of connected walls defining a perimeter of the engagement element, the plurality of walls having an upper rim and lower rim, the upper rim defining a first opening and the lower rim defining a second opening, the first and second opening being connected, at least one male engagement element on both the upper rim and the lower rim, the male engagement elements configured to releasably engage with the female engagement element of lid on one side, and another female engagement element on the opposite side.

In some embodiments, the perimeter can be generally square shaped.

Also disclosed herein is a display for a modular household storage system, said display can comprise a bottom portion comprising an outer wall that defines an interior space, a bottom wall connected to the outer wall, and an upper rim that defines a perimeter of an open top, the upper rim having at least one first engagement element, a double-sided first engagement piece comprising an outer wall that defines an interior space, a lower rim that defines a perimeter of an open bottom, and an upper rim that defines a perimeter of an open top, both the lower rim and upper rim having at least one second engagement element, a double-sided second engagement piece comprising an outer wall that defines an interior space, a lower rim that defines a perimeter of an open bottom, and an upper rim that defines a perimeter of an open top, both the lower rim and upper rim having at least one first engagement element, a top portion comprising a top wall and a lower rim, the lower rim having at least one second engagement element, wherein at least one of the second engagement elements of the double-sided first engagement piece is configured to releasably engage the first engagement element of the bottom portion, and at least another of the second engagement elements of the double-sided first engagement piece located on an opposite side of the outer wall is configured to releasably engage the first engagement element of the double-sided second engagement piece, and wherein at least one of the first engagement elements of the double-sided second engagement piece is configured to releasably engage the second engagement element of top portion, and at least another of the first engagement elements of the double-sided second engagement piece located on an opposite side of the outer wall is configured to releasably engage the second engagement element of the double-sided first engagement piece.

In some embodiments, each of the top portion, bottom portion, double-sided second engagement piece, and double-sided first engagement piece can be located in at least one bin. In some embodiments, at least two of the top portion, bottom portion, double-sided second engagement piece, and double-sided first engagement piece can be located in a same bin.

Also disclosed herein is a variable sized storage container, said variable sized storage container can comprise a bottom component having a bottom component storage area, the bottom component comprising one of a male or female engagement element, a top component, the top component comprising another of the male or female engagement element opposite of the bottom component, a container extension component disposed between the top component and the bottom component and defining an open top and an open bottom with a container extension storage area in between, the container extension component configured to releasably attach to the at least one male or female engagement element of the bottom component on one side and the another of the male or female engagement element of the top component on an opposite side of the container extension, wherein the container extension storage area connects with the bottom component storage area, thereby increasing a storage capacity of the variable sized storage container.

In some embodiments, the container extension can comprise a plurality of extension components, each extension component having a male or female engagement element on opposite ends of the extension component and a component storage area, wherein each extension component has either male engagement elements or female engagement elements. In some embodiments, the container extension can comprise an even number of extension components.

### BRIEF DESCRIPTION OF THE DRAWINGS

FIG. 1 illustrates an exploded view of an embodiment of a modular storage system.

FIGS. 2A-B illustrate viewpoints of an embodiment of a base for a modular storage system.

FIGS. 3A-C illustrate embodiments of a female connector for a modular storage system.

FIGS. 4A-C illustrate viewpoints of an embodiment of a male connector for a modular storage system.

FIGS. 5A-C illustrate viewpoints of an embodiment of a lid for a modular storage system.

FIGS. 6A-B illustrate embodiments of a configuration of a modular storage system.

FIGS. 7A-B illustrate embodiments of a configuration of a modular storage system.

FIG. 8 illustrates an embodiment of a configuration of a modular storage system.

FIGS. 9A-B illustrates embodiments of a configuration of a modular storage system.

### DETAILED DESCRIPTION

Disclosed herein are embodiments of a modular storage system. In particular, the modular storage system can be used to store goods, such as food or clothing. In some embodiments, the modular storage system can be used in consumer and/or commercial products and applications. Embodiments of the modular storage system can be used to create sealed storage units of varying size to maximize space efficiency. Components within the modular storage system can be added or removed to change the dimensions of the modular storage system, this giving the modular storage system variable dimensions. For example, connector pieces can be added so that the modular storage system increases in height.

Accordingly, the dimensions of the modular storage system can be changed to fit within a desired location. For example, the modular storage system can be reduced in height to fit in small spaces, such as a shelf or a crawl space. However, the modular storage system can also be increased in heights to fit more items, and can be placed in a closet or an attic.

In some embodiments, the modular storage system can maintain water-tight integrity between all components. In some embodiments, the modular storage system can maintain air and/or vapor-tight integrity. In some embodiments, the modular storage system can maintain powder integrity, such as with flour. In some embodiments, the modular storage system may not have be air or water-tight, and the integrity of the modular storage system does not limit this disclosure.

In some embodiments, the modular storage system can be similar in size to standard household/commercial containers, such as Tupperware® and clothing/keepsakes/tools/craft/hobby/holiday decor storage boxes, such as Rubbermaid® or Sterilite®, and the type of storage box does not limit this disclosure. In some embodiments, certain components as described herein can be used in conjunction with such standard household/commercial containers.

### Modular Storage System

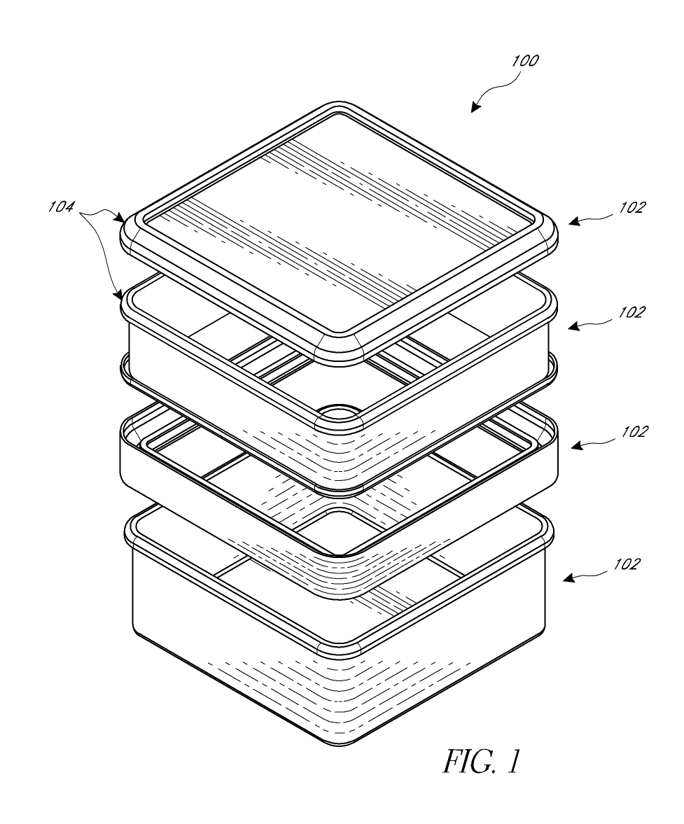

FIG. 1 illustrates an exploded perspective of an embodiment of a modular storage system. As shown, the modular storage system 100 can be formed from a number of different components 102. These components 102 can be selected from a variety of different components, as described in detail below. The type of components 102 used and their location in the modular storage system 100 does not limit the disclosure. In some embodiments, the corners 104 of the components 102 can be generally rounded so as to help prevent potential injury. In some embodiments, the components 102 can be configured to complement a specific other component 102. In some embodiments, the corners can be more angular, thus allowing the system 100 to fit tightly in corners.

In some embodiments, the components 102 can have a generally smooth and flat outer surface. This can help the system 100 fit properly in a storage area. However, in some embodiments, the components 102 can be fitted with, for example, holding means such as handles or grips. In some embodiments, the components 102 can have a rough or textured surface in order to increase grip on the system 102. In some embodiments, the components 102 can have attachment means on their inside, for example hooks, pins, and other holding means. In some embodiments, the components 102 may have a generally smooth flat inner surface. The surface roughness and attachment means do not limit this disclosure.

In some embodiments, the modular storage system 100 can be generally clear in shape, or sufficiently clear to view the contents of the modular storage system 100. In some embodiments, the modular storage system 100 can be generally opaque and the contents cannot be viewed from the outside. In some embodiments, the modular storage system 100 can have colors, patterns, textures, or transparency as could apply to any material such as, for example, plastic, wood, glass, metal, cardboard, or fabric covering. In some embodiments, different components 102 can have different or the same colors or patterns. In some embodiments, the components 102 can have portions that are opaque and portions that are transparent such as, for example, a window. However, the visibility and/or coloring of the modular storage system 100 does not limit the disclosure.

In some embodiments, the modular storage system 100 can be generally rigid. In some embodiments, the modular storage system 100 can have some flexibility. The rigidity of embodiments of the modular storage system 100 does not limit this disclosure.

In some embodiments, components 102 of the modular storage system 100 can be generally rectangular in shape. However, in some embodiments, the components 102 can have a different shape, such as a generally circular shape or a generally triangular shape. In some embodiments, connector pieces can have one side having one shape, such as a triangle, and the other side having a different shape, such as a rectangle. Therefore, in some embodiments, different shaped components 102 can be used in conjunction with one another. For example, the components 102 can be generally rectangular, generally triangular, generally circular, generally round, generally oval, generally cylindrical, or generally trapezoidal. However, the shapes of the modular storage system 100 do not limit the disclosure.

In some embodiments, the modular storage system 100 can be sized similar to plastic bins. For example, the modular storage system 100 can have a width, length, and or diameter of about 0.5, 1, 1.5, 2, 2.5, 3, 3.5, 4, 4.5, or 5 feet. In some embodiments, the modular storage system 100 can have a width, length, and or diameter of greater than about 0.5, 1, 1.5, 2, 2.5, 3, 3.5, 4, 4.5, or 5 feet. In some embodiments, the modular storage system 100 can have a width, length, and or diameter of less than about 0.5, 1, 1.5, 2, 2.5, 3, 3.5, 4, 4.5, or 5 feet. While the overall height of the modular storage system 100 can vary, as described below, in some embodiments the modular storage system 100 can have a height of about 1, 1.5, 2, 2.5, or 3 feet. In some embodiments the modular storage system 100 can have a height of greater than about 1, 1.5, 2, 2.5, 3, 3.5, 4, 4.5, or 5 feet. In some embodiments each of the components 102 can have a height of less than about 1, 1.5, 2, 2.5, 3, 3.5, 4, 4.5, or 5 feet.

In some embodiments, the modular storage system 100 can be sized similar to food storage containers. For example, the modular storage system 100 can have a width, length, and or diameter of about 2, 2.5, 3, 3.5, 4, 4.5, 5, 5.5, 6, 6.5, 7, 7.5, 8, 8.5, 9, 9.5 or 10 inches. In some embodiments, the modular storage system 100 can have a width, length, and or diameter of greater than about 2, 2.5, 3, 3.5, 4, 4.5, 5, 5.5, 6, 6.5, 7, 7.5, 8, 8.5, 9, 9.5 or 10 inches. In some embodiments, the modular storage system 100 can have a width, length, and or diameter of less than about 2, 2.5, 3, 3.5, 4, 4.5, 5, 5.5, 6, 6.5, 7, 7.5, 8, 8.5, 9, 9.5 or 10 inches. In some embodiments, the modular storage system 100 can have a height of about 2, 2.5, 3, 3.5, 4, 4.5, 5, 5.5, 6, 6.5, 7, 7.5, 8, 8.5, 9, 9.5 or 10 inches. In some embodiments, the modular storage system 100 can have a height of greater than about 2, 2.5, 3, 3.5, 4, 4.5, 5, 5.5, 6, 6.5, 7, 7.5, 8, 8.5, 9, 9.5 or 10 inches. In some embodiments, the modular storage system 100 can have a height of less than about 2, 2.5, 3, 3.5, 4, 4.5, 5, 5.5, 6, 6.5, 7, 7.5, 8, 8.5, 9, 9.5 or 10 inches.

In some embodiments, the components 102 can be sized similar to plastic bins. For example, the components 102 can have a width, length, and or diameter of about 0.5, 1, 1.5, 2, 2.5, 3, 3.5, 4, 4.5, or 5 feet. In some embodiments, the components 102 can have a width, length, and or diameter of greater than about 0.5, 1, 1.5, 2, 2.5, 3, 3.5, 4, 4.5, or 5 feet. In some embodiments, the components 102 can have a width, length, and or diameter of less than about 0.5, 1, 1.5, 2, 2.5, 3, 3.5, 4, 4.5, or 5 feet. While the overall height of the components 102 can vary, as described below, in some embodiments the components 102 can have a height of about 1, 1.5, 2, 2.5, or 3 feet. In some embodiments the components 102 can have a height of greater than about 1, 1.5, 2, 2.5, or 3 feet. In some embodiments the components 102 can have a height of less than about 1, 1.5, 2, 2.5, or 3 feet.

In some embodiments, the components 102 can be sized similar to food storage containers. For example, the components 102 can have a width, length, and or diameter of about 2, 2.5, 3, 3.5, 4, 4.5, 5, 5.5, 6, 6.5, 7, 7.5, 8, 8.5, 9, 9.5 or 10 inches. In some embodiments, the components 102 can have a width, length, and or diameter of greater than about 2, 2.5, 3, 3.5, 4, 4.5, 5, 5.5, 6, 6.5, 7, 7.5, 8, 8.5, 9, 9.5 or 10 inches. In some embodiments, the components 102 can have a width, length, and or diameter of less than about 2, 2.5, 3, 3.5, 4, 4.5, 5, 5.5, 6, 6.5, 7, 7.5, 8, 8.5, 9, 9.5 or 10 inches. In some embodiments, the components 102 can have a height of about 2, 2.5, 3, 3.5, 4, 4.5, 5, 5.5, 6, 6.5, 7, 7.5, 8, 8.5, 9, 9.5 or 10 inches. In some embodiments, the components 102 can have a height of greater than about 2, 2.5, 3, 3.5, 4, 4.5, 5, 5.5, 6, 6.5, 7, 7.5, 8, 8.5, 9, 9.5 or 10 inches. In some embodiments, the components 102 can have a height of less than about 2, 2.5, 3, 3.5, 4, 4.5, 5, 5.5, 6, 6.5, 7, 7.5, 8, 8.5, 9, 9.5 or 10 inches.

In some embodiments, each of the components 102 can have generally the same height. In some embodiments, the components 102 can have different heights.

In some embodiments, the width of the components 102 can be the same as the length. In some embodiments, the width of the components 102 can be different from the length. In some embodiments, the components 102 can change in width, length, or diameter throughout the height of the component 102. For example, the base of a component 102 can be smaller than the top. In some embodiments, the diameter can be the same throughout the whole modular storage system 100. In some embodiments, the diameter can vary. The size of the modular storage system 100 does not limit this disclosure.

In some embodiments, the modular storage system can include three basic components: (1) ends; (2) double sided female connectors; and (3) double-sided male connectors. In some embodiments, the double-sided female connector can be hollow or can have a shelf, as disclosed below. The ends can be pieces such as containers and/or lids, as further described below. The connectors can be used between the ends, and as more connectors are used, the system 100 can increase in height. Connectors are easily added or removed so that the height of the system 100 can vary to any desired height, as described above. The height of the modular storage system 100 can vary depending on what components are used.

In some embodiments, the male connectors can have male connection elements on both the top and bottom. Similarly, in some embodiments the female connectors can have female connection elements on the top and bottom. However, other types of connectors can be used as well. For example, the female and male connectors can be replaced with connector pieces that fit together in a different fashion. For example, embodiments of the disclosed connectors can use friction engagement, magnetic engagement, interference engagement, tongue-in-groove engagement, or twist-and-lock engagement. In some embodiments, one engagement element can have a series of patterns and an opposite engagement element can have mating, sealing, and/or engagement elements. Therefore, the two engagement elements can fit together and releasably lock in place. In some embodiments, the engagement elements can be generally configured to releasably mate with one another, and the type of mating is not limiting.

### Components of the Modular Storage System

Described in detail below are certain type of components 102 that may be used in a modular storage system 100. As disclosed, these components 102 can desirably be used in multiple combinations.

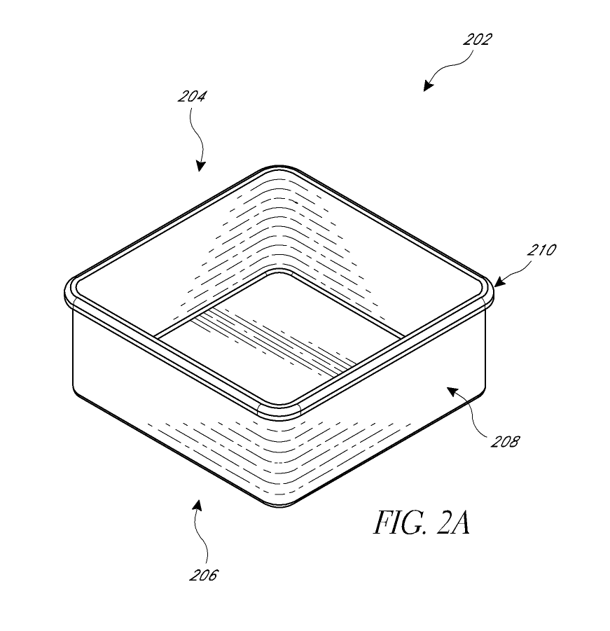

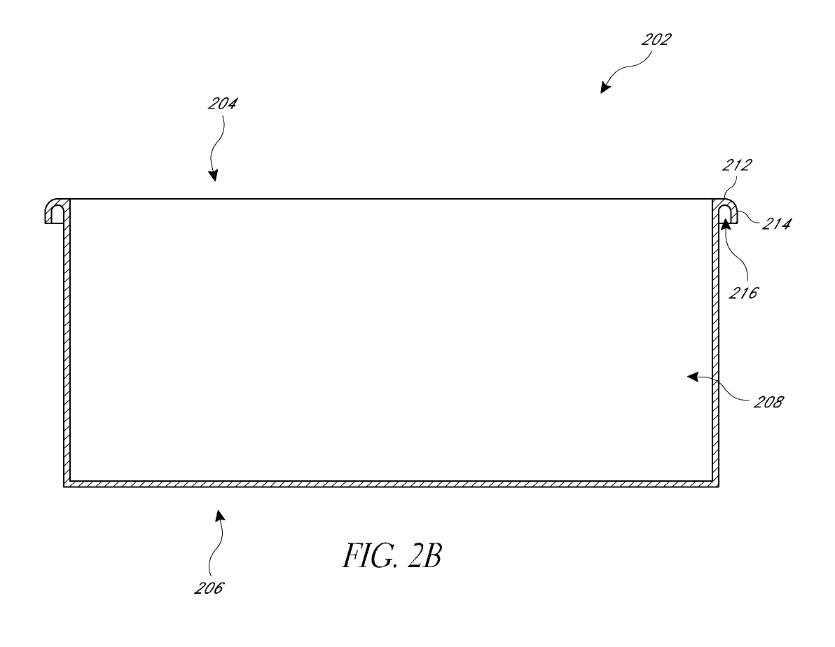

FIGS. 2A-B illustrate two perspectives of an embodiment of a container end component. As shown in FIG. 2A, the container 202 can be generally rectangular in shape. In some embodiments, one end 204 of the container 202 can be open. The container 202 can further contain a second end 206 which forms a closed bottom, as well as sidewalls 208 extending between the ends 204/206. In some embodiments the sidewalls 208 can be one continuous piece. In some embodiments, the sidewalls 208 can be made of separate pieces that are attached together. As mentioned above, the actual height of the sidewalls 208 does not limit this disclosure. In some embodiments, the container 202 can be sized to fit food. In some embodiments, the container 202 can be sized to fit clothing.

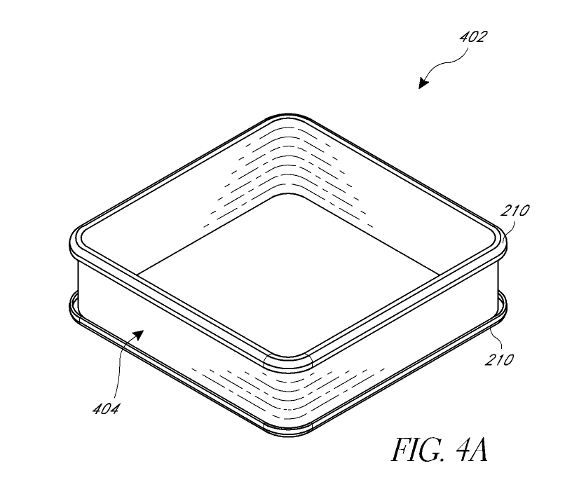

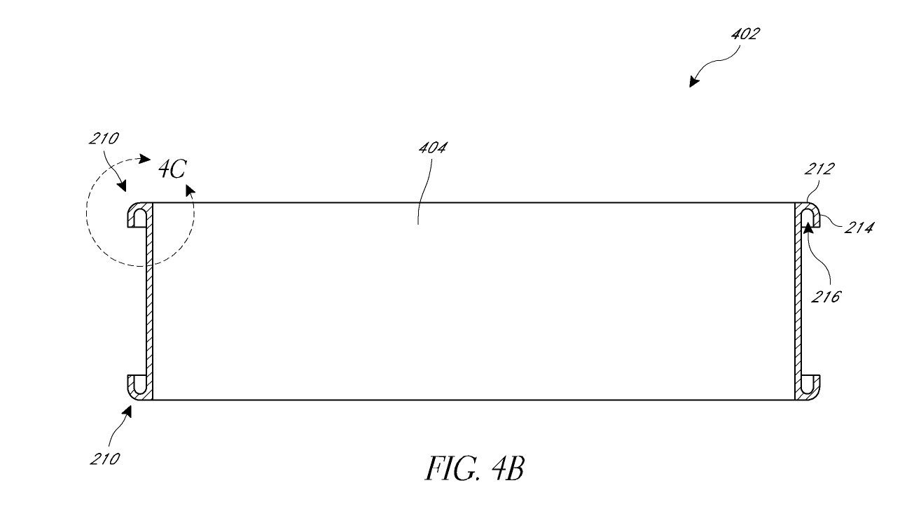

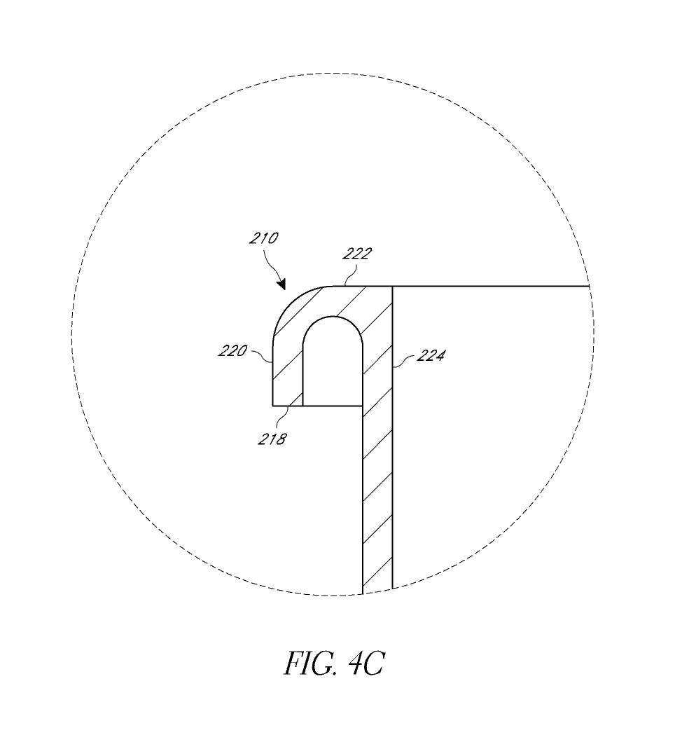

FIGS. 2A-B also show an embodiment of an attachment portion. As shown in FIGS. 2B, the container 202 can have a male attachment portion 210 (a zoomed in view is shown in FIG. 4C). However, the type of attachment portion does not limit the disclosure, and a female attachment portion can be used as well as, or instead of, the male attachment portion 210. FIG. 2B is an illustration of a cross-sectional view showing an embodiment of a configuration of the male attachment portion 210. As shown, the male attachment portion 210 can occur at one end of sidewall 208 opposite the second end 206. In some embodiments, the male attachment portion 210 can be a continuous piece with the sidewall 208. In some embodiments, the male attachment portion 210 can be a separate piece or pieces that are attached to the sidewall 208. At the male attachment portion 210, the sidewall 208 can curve outwards to form a top curve 212 and attachment end 214 and extend generally back in the direction of the second end 206. In some embodiments, the attachment end 214 touches, or is connected to, the sidewall 208. In some embodiments, the attachment end 214 is separate from the sidewall 208. In some embodiments, the male attachment portion 210 can curve inwards, instead of the as shown outward curve. In some embodiments, more than one male attachment portion 210 can be located on a sidewall 208. In some embodiments, the male attachment portion 210 can be on one sidewall 208. In some embodiments, male attachment portion 210 can be on two sidewalls 208. In some embodiments, the male attachment portion 210 can be on adjacent sidewalls 208 or opposite sidewalls 208. In some embodiments, the male attachment portion 210 can be on three sidewalls 208. In some embodiments, the male attachment portion 210 can be on all of the sidewalls 208. In some embodiments, the sidewalls 208 can have 1, 2, 3, 4, or 5 male attachment portions 210.

In some embodiments, the male attachment portion 210 can extend about 0.5, 0.6, 0.7, 0.8, 0.9, 1.0, 2.0, 3.0, 4.0, or 5.0 inches between the top curve 212 and the attachment end 214. In some embodiments, the male attachment portion 210 can extend less than about 0.5, 0.6, 0.7, 0.8, 0.9, 1.0, 2.0, 3.0, 4.0, or 5.0 inches between the top curve 212 and the attachment end 214. In some embodiments, there can be a space 216 between the attachment end 214 and the sidewall 208. In some embodiments, the space 216 can be about 0.1, 0.2, 0.3, 0.4, 0.5, 0.6, 0.7, 0.8, 0.9, 1.0, 2.0, 3.0, 4.0, or 5.0 inches. In some embodiments, the space 216 can be less than about 0.1, 0.2, 0.3, 0.4, 0.5, 0.6, 0.7, 0.8, 0.9, 1.0, 2.0, 3.0, 4.0, or 5.0 inches. The male attachment portion 210 can be configured to connect with a female attachment portion further described below. In some embodiments, the male attachment portion 210 can be flexible. In some embodiments, the male attachment portion 210 may be rigid.

In some embodiments, the male attachment portion 210 can extend the full length of a sidewall 208. In some embodiments, the male attachment portion 210 can extend only part of the length of sidewall 208. In some embodiments, the male attachment portion 210 can extend about 0.5, 0.6, 0.7, 0.8, 0.9, 1.0, 2.0, 3.0, 4.0, or 5.0 inches along the sidewall 208. In some embodiments, the male attachment portion 210 can extend less than about 0.5, 0.6, 0.7, 0.8, 0.9, 1.0, 2.0, 3.0, 4.0, or 5.0 inches along the sidewall 208. In some embodiments, the male attachment portion 210 can be about 1/16, 1/15, 1/14, 1/13, 1/12, 1/10, 1/9, ⅛, 1/7, ⅙, ⅕, ¼, ⅓, or ½ of sidewall 208.

Disclosed is a configuration of a male attachment means, but the means does not limit the disclosure and any general type of male attachment means known in the art can be used and can be advantageous.

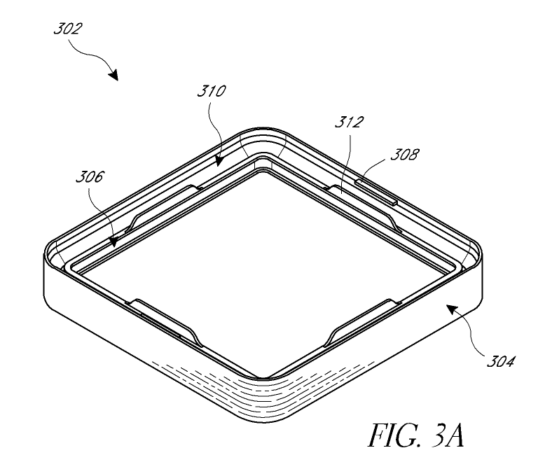

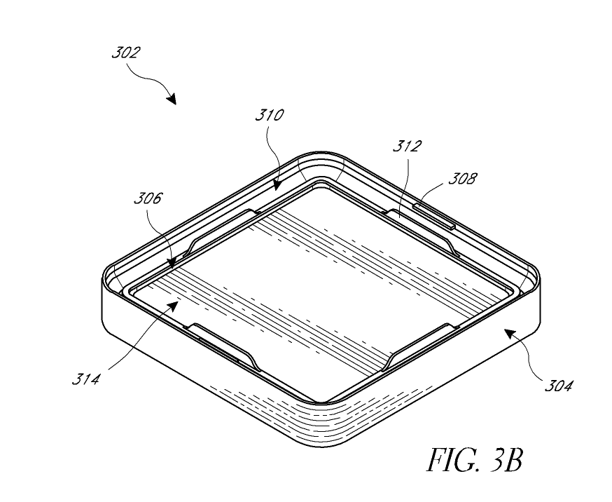

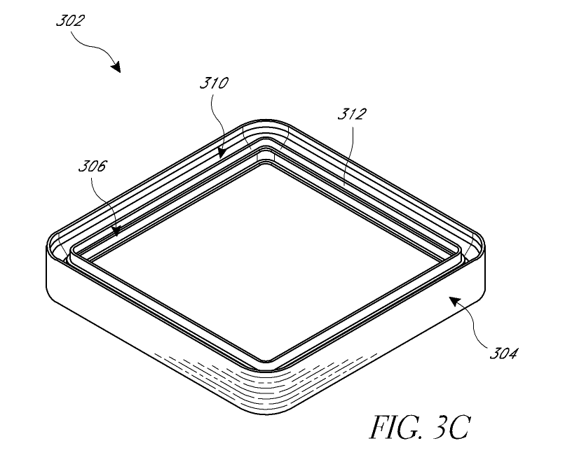

FIG. 3A illustrates a perspective of an embodiment of a double-sided female connector 302. The double-sided female connector 302 can also be known as a Link™. As shown, the double-sided female connector 302 can be generally rectangular in shape and can be formed by a series of sidewalls 304. In some embodiments the sidewalls 304 can be one continuous piece. In some embodiments, the sidewalls 304 can be made of separate pieces that are attached together. As shown in FIG. 3A, the female connector 302 can be open at both ends of the sidewalls 304. As mentioned above, the actual height of the sidewalls 304 does not limit this disclosure. While FIG. 3A shows a generally rectangular shaped connector 302, the connector 302 could be other shapes such as generally circular or generally oval.

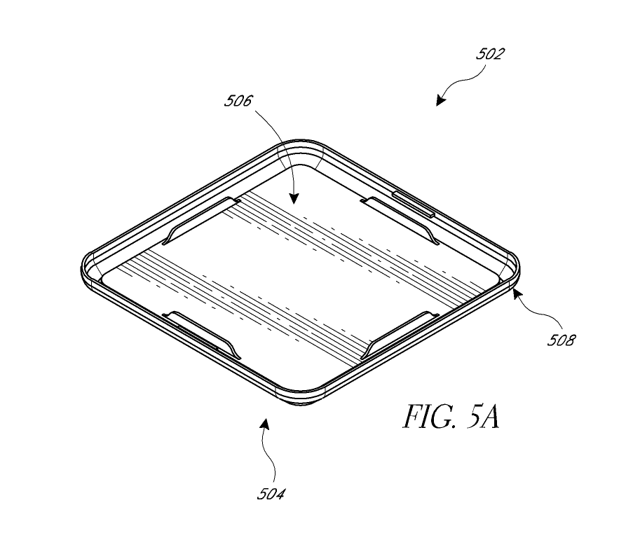

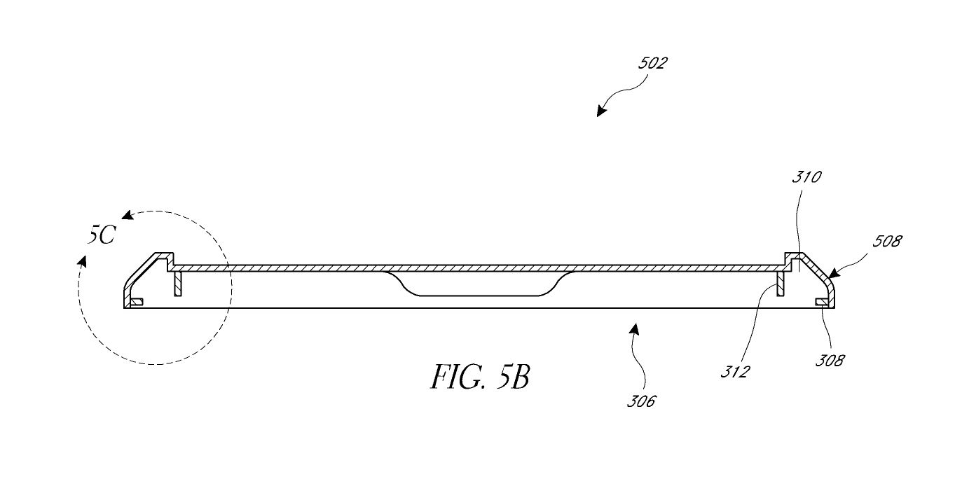

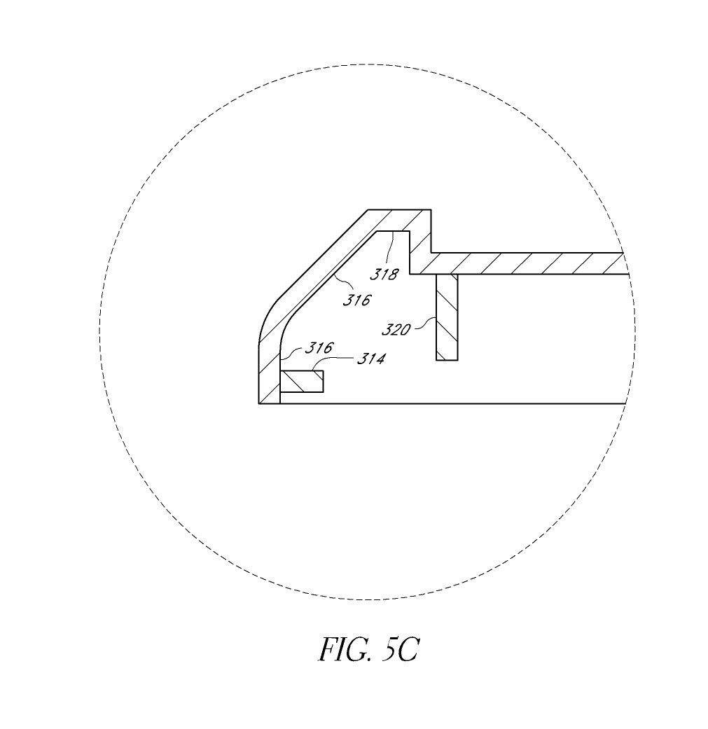

The double-sided female connector 302 can have at least one pair of female attachment portions 306 that can accept a male attachment portion 210 on both the top and bottom rim of the double-sided female connector 302 (a zoomed in view is shown in FIG. 5C). In some embodiments, the double-sided female connector 302 can have a pair of female attachment portions 306 on the top and bottom of one sidewall 304. In some embodiments, the double-sided female connector 302 can have a pair of female attachment portions 306 on the top and bottom of two sidewalls 304. The female attachment portion 306 can be on adjacent sidewalls 304 or opposite sidewalls 304. In some embodiments, the double-sided female connector 302 can have a female attachment portion 306 on three sidewalls 304. In some embodiments, the double-sided female connector 302 can have a female attachment portion 306 on all of the sidewalls 304. In some embodiments, the sidewalls 304 can have 1, 2, 3, 4, or 5 pairs of female attachment portion 306. In some embodiments, the female attachment portions 306 can be located generally central on the sidewall 304. In some embodiments, the female attachment portions 306 on opposite sides can be located generally across from each other. In some embodiments, the female attachment portions 306 on opposite sides can be located in different locations from each other. In some embodiments, the top of the double-sided female connector 302 can have a different number of female attachment portions 306 than the bottom. In some embodiments, the top of the double-sided female connector 302 can have the same number of female attachment portions 306 than the bottom.

As shown in FIG. 3A, in some embodiments the female attachment portion 306 can be made up of a locking portion, such as a locking tab, 308, attachment space 310, and guide portion, such as a guide tab, 312. The attachment space 310 can be configured to accept a male attachment portion 210, including the top curve 212 and attachment end 214. When the male attachment portion 210 is inserted into the female attachment portion 306, the locking tab 308 can flex slightly outwards. Once the male attachment portion 210 is in place, the locking tab 308 can flex back into its original space to cover and hold on to the attachment end 214. For example, the locking tab, or air tight pressure seal, 308 can cover the top of the attachment end 214, thus holding it in place. To remove the male attachment portion 210, the locking tab 308 can be flexed outwards, thus freeing up the attachment end 214. The guide tab 312 can be used to contain the male attachment portion 210 in the attachment space 310.

In some embodiments, the guide tab 312 can be located about 0.1, 0.2, 0.3, 0.4, 0.5, 0.6, 0.7, 0.8, 0.9, 1.0, 2.0, 3.0, 4.0, or 5.0 inches from the inside of sidewall 304. In some embodiments, the guide tab 312 can be located less than about 0.1, 0.2, 0.3, 0.4, 0.5, 0.6, 0.7, 0.8, 0.9, 1.0, 2.0, 3.0, 4.0, or 5.0 inches from the inside of sidewall 304. In some embodiments, the attachment space 310 can be about 0.1, 0.2, 0.3, 0.4, 0.5, 0.6, 0.7, 0.8, 0.9, 1.0, 2.0, 3.0, 4.0, or 5.0 inches. In some embodiments, the attachment space 310 can be less than about 0.1, 0.2, 0.3, 0.4, 0.5, 0.6, 0.7, 0.8, 0.9, 1.0, 2.0, 3.0, 4.0, or 5.0 inches. In some embodiments, the locking tab 308 can extend about 0.1, 0.2, 0.3, 0.4, 0.5, 0.6, 0.7, 0.8, 0.9, 1.0, 2.0, 3.0, 4.0, or 5.0 inches from the inside of sidewall 304. In some embodiments, the locking tab 308 can extend less than 0.5, 0.6, 0.7, 0.8, 0.9, 1.0, 2.0, 3.0, 4.0, or 5.0 inches from the inside of sidewall 304. In some embodiments, the locking tab 308 can contact the guide tab 312. In some embodiments, the locking tab 308 may not contact the guide tab 312. In some embodiments, the locking tab 308 may extend generally the length of the sidewall 308. In some embodiments, the locking tab 308 can extend about 0.5, 0.6, 0.7, 0.8, 0.9, 1.0, 2.0, 3.0, 4.0, or 5.0 inches along the sidewall 304. In some embodiments, the locking tab 308 can extend less than about 0.5, 0.6, 0.7, 0.8, 0.9, 1.0, 2.0, 3.0, 4.0, or 5.0 inches along the sidewall 304. In some embodiments, the locking tab 308 can extend about 0.1, 0.2, 0.3, 0.4, 0.5, 0.6, 0.7, 0.8, 0.9, or 1.0 feet along the sidewall 304. In some embodiments, the locking tab 308 can extend less than about 0.1, 0.2, 0.3, 0.4, 0.5, 0.6, 0.7, 0.8, 0.9, or 1.0 feet along the sidewall 304. In some embodiments, the guide tab 312 can extend about 0.5, 0.6, 0.7, 0.8, 0.9, 1.0, 2.0, 3.0, 4.0, or 5.0 inches along the sidewall 304. In some embodiments, the guide tab 312 can extend less than about 0.5, 0.6, 0.7, 0.8, 0.9, 1.0, 2.0, 3.0, 4.0, or 5.0 inches along the sidewall 304. In some embodiments, the guide tab 312 can extend about 0.1, 0.2, 0.3, 0.4, 0.5, 0.6, 0.7, 0.8, 0.9 or 1.0 feet along the sidewall 304. In some embodiments, the guide tab 312 can extend less than about 0.1, 0.2, 0.3, 0.4, 0.5, 0.6, 0.7, 0.8, 0.9, or 1.0 feet along the sidewall 304. In some embodiments, multiple guide tabs 312 or locking tabs 308 can be used on each sidewall 304.

FIG. 3B shows an embodiment of a double-sided female connector 302. As shown, the connector 302 is a similar size and shape to the connector of FIG. 3A, though the size and shape does not limit the disclosure. Advantageously, the connector 302 shown in FIG. 3B can also contain a separator, or shelf, 314. This separator 314 can be planar and extend across the entire width and length of the connector 302, thus creating a separator partition so that liquids and solids cannot pass completely through the connector 302. Embodiments of the connector 302 having the separator 314 can be used to partition different components 102 of the modular storage system 100. In some embodiments, the connector 302 can be located generally midway in the thickness of the connector 302. In some embodiments, the connector 302 can be not at the midpoint in the thickness of the connector 302. In some embodiments, the connector 302 can have a thickness of about 0.1, 0.3, 0.5, 0.7, 0.9, or 1 inches. In some embodiments, the connector 302 can have a thickness of less than about 0.1, 0.3, 0.5, 0.7, 0.9, or 1 inches. In some embodiments, the connector 302 can have a thickness of greater than about 0.1, 0.3, 0.5, 0.7, 0.9, or 1 inches.

FIG. 3C shows an embodiment of a double-sided female connector 302. As shown, the connector 302 is a similar size and shape to the connector of FIG. 3A, though the size and shape does not limit the disclosure. Advantageously, the female attachment portion 306 can be modified from those shown in FIG. 3A. As shown, the female attachment portion 306 of FIG. 3C may not have a locking tab 308. Although in some embodiments the locking tab 308 can remain. The guide tab 312 can extend fully around the circumference of the connector 302, thus creating a generally unbroken attachment space 310. For example, this female attachment portion 306 can be configured to work with containers similar to Tupperware® brand containers.

Disclosed is a configuration of a female attachment means, but the means does not limit the disclosure and any general type of female attachment means known in the art can be used.

FIGS. 4A-B illustrate two perspectives of an embodiment of a double-sided male connector 402. The double-sided male connector 402 can also be known as a Cuff™. As shown in FIG. 4A, the double-sided male connector 402 can be generally rectangular in shape and can be formed by a series of sidewalls 404. In some embodiments the sidewalls 404 can be one continuous piece. In some embodiments, the sidewalls 404 can be made of separate pieces that are attached together. As shown in FIG. 4A, the double-sided male connector 402 can be open at both ends of the sidewalls 404, similar to the double-sided female connector 302 described above. As mentioned above, the actual height of the sidewalls 404 does not limit this disclosure. While FIGS. 4A-B show a generally rectangular shaped connector 402, the connector 402 could be other shapes such as generally circular or generally oval.

As shown in the interior perspective of FIG. 4B, the double-sided male connector 402 can have at least one pair of male attachment portions 210 that can be inserted into a female attachment portion 306 on both the top and bottom rims of the double-sided male connector 402. In some embodiments, the male attachment portion 210 can be a continuous piece as the sidewall 404. In some embodiments, the male attachment portion 210 can be a separate pieces that is attached to the sidewall 404. At the male attachment portion 210, the sidewall 208 can curve outwards to form a top curve 212 and attachment end 214 and extend generally back in the direction of a male attachment portion 210 on the opposite side of the sidewall 404. In some embodiments, the attachment end 214 touches, or is connected to, the sidewall 404. In some embodiments, the attachment end 214 is separate from the sidewall 404. In some embodiments, the male attachment portion 210 can curve inwards, instead of the as shown outward curve. In some embodiments, more than one male attachment portion 210 can be located on a sidewall 404.

In some embodiments, the pair of male attachment portions 210 can be on one sidewall 404. In some embodiments, the pair of male attachment portions 210 can be on two sidewalls 404. The pair of male attachment portions 210 can be on adjacent sidewalls 404 or opposite sidewalls 404. In some embodiments, the pair of male attachment portions 210 can be on three sidewalls 404. In some embodiments, the pair of male attachment portions 210 can be on all of the sidewalls 404. In some embodiments, the sidewalls 404 can have 1, 2, 3, 4, or 5 pairs of male attachment portions 210.

FIG. 4C shows an enlarged cross-sectional view of the male attachment portion 210. As shown, the top curve 212 can have an engagement surface 222 extending away from the double-sided male connector 402. The top curve 212 can extend towards the attachment end 214 on interference surface 220. The attachment end 214 can end with locking surface 218. Opposite the interference surface 220, the top curve 212 can extend into a sidewall surface 224 which proceeds into the sidewall 404. In some embodiments, the locking surface 218 and engagement surface 222 are generally parallel. In some embodiments, the interference surface 220 and sidewall surface 224 are generally parallel. In some embodiments, the interference surface 220 and sidewall surface 224 are generally transverse to the locking surface 218 and engagement surface 222.

In some embodiments, the male attachment portion 210 can extend about 0.5, 0.6, 0.7, 0.8, 0.9, 1.0, 2.0, 3.0, 4.0, or 5.0 inches between the top curve 212 and the attachment end 214. In some embodiments, the male attachment portion 210 can extend less than about 0.5, 0.6, 0.7, 0.8, 0.9, 1.0, 2.0, 3.0, 4.0, or 5.0 inches between the top curve 212 and the attachment end 214. In some embodiments, there can be a space 216 between the attachment end 214 and the sidewall 208. In some embodiments, the space 216 can be about 0.1, 0.2, 0.3, 0.4, 0.5, 0.6, 0.7, 0.8, 0.9, 1.0, 2.0, 3.0, 4.0, or 5.0 inches. In some embodiments, the space 216 can be less than about 0.1, 0.2, 0.3, 0.4, 0.5, 0.6, 0.7, 0.8, 0.9, 1.0, 2.0, 3.0, 4.0, or 5.0 inches. The male attachment portion 210 can be configured to connect with a female attachment portion further described below. In some embodiments, the male attachment portion 210 can be flexible. In some embodiments, the male attachment portion 210 may be rigid.

In some embodiments, the male attachment portion 210 can extend the full length sidewall 404. In some embodiments, the male attachment portion 210 can extend only part of the length of sidewall 404. In some embodiments, the male attachment portion 210 can extend about 0.5, 0.6, 0.7, 0.8, 0.9, 1.0, 2.0, 3.0, 4.0, or 5.0 inches along the sidewall 404. In some embodiments, the male attachment portion 210 can extend less than about 0.5, 0.6, 0.7, 0.8, 0.9, 1.0, 2.0, 3.0, 4.0, or 5.0 inches along the sidewall 404. In some embodiments, the male attachment portion 210 can extend about 0.1, 0.2, 0.3, 0.4, 0.5, 0.6, 0.7, 0.8, 0.9, or 1.0 feet along the sidewall 404. In some embodiments, the male attachment portion 210 can extend less than about 0.1, 0.2, 0.3, 0.4, 0.5, 0.6, 0.7, 0.8, 0.9, or 1.0 feet along the sidewall 404. In some embodiments, the male attachment portion 210 can be about 1/16, 1/15, 1/14, 1/13, 1/12, 1/10, 1/9, ⅛, 1/7, ⅙, ⅕, ¼, ⅓, or ½ of sidewall 404.

Disclosed is a configuration of a male attachment means, but the means does not limit the disclosure and any general type of male attachment means known in the art can be used.

FIGS. 5A-B illustrate two perspectives of an embodiment of a top end, or lid, component. As shown in FIG. 5A, the top 502 can be generally rectangular in shape. In some embodiments, one end of the top 502 can be open 504. The top 502 can further contain a closed top 506, as well as sidewalls 508. In some embodiments the sidewalls 508 can be one continuous piece. In some embodiments, the sidewalls 508 can be made of separate pieces that are attached together. In some embodiments, the sidewalls 508 of top 502 can be generally ½, ⅓, ¼, ⅕, ⅙, 1/7, ⅛, 1/9, 1/10, 1/15, 1/20, 1/30, 1/40, or 1/50 the side of the sidewalls 208 of container 202. In some embodiments, the sidewalls 508 of top 502 can be less than generally ½, ⅓, ¼, ⅕, ⅙, 1/7, ⅛, 1/9, 1/10, 1/15, 1/20, 1/30, 1/40, or 1/50 the side of the sidewalls 208 of container 202. In some embodiments, the sidewalls 508 of top 502 can be greater than generally ½, ⅓, ¼, ⅕, ⅙, 1/7, ⅛, 1/9, 1/10, 1/15, 1/20, 1/30, 1/40, or 1/50the side of the sidewalls 208 of container 202. As mentioned above, the actual height of the sidewalls 508 does not limit this disclosure. In some embodiments, the top 502 can be sized to fit food. In some embodiments, the top 502 can be sized to fit clothing.

FIGS. 5A-C also show embodiments of attachment portions. As shown in FIGS. 5A-B the top 502 can have a female attachment portion 510. However, the type of attachment portion does not limit the disclosure, and a male attachment portion can be used as well as, or instead of, the female attachment portion 510. In some embodiments, the top 302 can have the opposite attachment portion of the container 202 so that they can releasably fit together.

FIG. 5B illustrates an internal viewpoint showing an embodiment of a configuration of the female attachment portion 306. As shown, the female attachment portion 306 can extend inward from sidewall 508. The female connector 302 can have at one female attachment portion 306 that can accept a male attachment portion 210 on the open bottom 502 of the top 502. In some embodiments, the female connector 302 can have a female attachment portion 306 on only one sidewall 508. In some embodiments, the top 502 can have a female attachment portion 306 on two sidewalls 508. The female attachment portion 306 can be on adjacent sidewalls 508 or opposite sidewalls 508. In some embodiments, the top 502 can have a female attachment portion 306 on three sidewalls 508. In some embodiments, the top 502 can have a female attachment portion 306 on all of the sidewalls 508. In some embodiments, the sidewalls 508 can have 1, 2, 3, 4, or 5 pairs of female attachment portion 306. In some embodiments, the female attachment portion 306 can be located generally central on the sidewall 508.

FIG. 5B shows a close up of the female attachment portion 306. In some embodiments, the female attachment portion 306 can be made up of a locking portion, such as a tab, 308, attachment space 310, and guide portion, such as a tab, 312. The attachment space 310 can be configured to accept a male attachment portion 210. When the male attachment portion 210 is inserted into the female attachment portion 306, the locking tab 308 can flex slightly outwards. Once the male attachment portion 210 is in place, the locking tab 308 can flex back into its original space to hold onto the attachment end 214. For example, the locking tab 308 can cover the top of the attachment end 214, thus holding it in place. To remove the male attachment portion 210, the locking tab 308 can be flexed outwards, thus freeing up the attachment end 214. The guide tab 312 can be used to contain the male attachment portion 210 in the attachment space 310.

FIG. 5C shows an enlarged cross-sectional view of female attachment portion 306. As shown, the attachment space 310 can be surrounded by a plurality of surfaces. Interference surfaces 316, 318, and 320 are configured to accept and retain the male attachment portion 210. While FIG. 5C shows surface 316 as being curved, in some embodiments surface 316 can be generally straight and parallel to surface 320. Surface 316 can interact with interference surface 220. Surface 318 can interact with engagement surface 222. Surface 320 can interact with sidewall surface 224. Female locking surface 314 can interact with the male locking surface 218, thereby releasably holding the male engagement portion 210 in the female attachment portion 304. Female locking surface 314 can be configured to translate, thus allowing the male attachment portion 210 insert into the attachment space 310 of the female attachment portion 306. In some embodiments, surface 314 can be generally parallel to surface 318.

In some embodiments, the guide tab 312 can be located about 0.1, 0.2, 0.3, 0.4, 0.5, 0.6, 0.7, 0.8, 0.9, 1.0, 2.0, 3.0, 4.0, or 5.0 inches from the inside of sidewall 508. In some embodiments, the guide tab 312 can be located less than about 0.1, 0.2, 0.3, 0.4, 0.5, 0.6, 0.7, 0.8, 0.9, 1.0, 2.0, 3.0, 4.0, or 5.0 inches from the inside of sidewall 508. In some embodiments, the attachment space 310 can be about 0.1, 0.2, 0.3, 0.4, 0.5, 0.6, 0.7, 0.8, 0.9, 1.0, 2.0, 3.0, 4.0, or 5.0 inches. In some embodiments, the attachment space 310 can be less than about 0.1, 0.2, 0.3, 0.4, 0.5, 0.6, 0.7, 0.8, 0.9, 1.0, 2.0, 3.0, 4.0, or 5.0 inches. In some embodiments, the locking tab 308 can extend about 0.5, 0.6, 0.7, 0.8, 0.9, 1.0, 2.0, 3.0, 4.0, or 5.0 inches from the inside of sidewall 508. In some embodiments, the locking tab 308 can extend less than about 0.5, 0.6, 0.7, 0.8, 0.9, 1.0, 2.0, 3.0, 4.0, or 5.0 inches from the inside of sidewall 508. In some embodiments, the locking tab 308 can contact the guide tab 312. In some embodiments, the locking tab 308 may not contact the guide tab 312. In some embodiments, the locking tab 308 may extend generally the length of the sidewall 508. In some embodiments, the locking tab 308 can extend about 0.5, 0.6, 0.7, 0.8, 0.9, 1.0, 2.0, 3.0, 4.0, or 5.0 inches along the sidewall 508. In some embodiments, the locking tab 308 can extend less than about 0.5, 0.6, 0.7, 0.8, 0.9, 1.0, 2.0, 3.0, 4.0, or 5.0 inches along the sidewall 508. In some embodiments, the locking tab 308 can extend about 0.1, 0.2, 0.3, 0.4, 0.5, 0.6, 0.7, 0.8, 0.9, or 1.0 feet along the sidewall 508. In some embodiments, the locking tab 308 can extend less than about 0.1, 0.2, 0.3, 0.4, 0.5, 0.6, 0.7, 0.8, 0.9, or 1.0 feet along the sidewall 508. In some embodiments, the guide tab 312 can extend about 0.5, 0.6, 0.7, 0.8, 0.9, 1.0, 2.0, 3.0, 4.0, or 5.0 inches along the sidewall 508. In some embodiments, the guide tab 312 can extend less than about 0.5, 0.6, 0.7, 0.8, 0.9, 1.0, 2.0, 3.0, 4.0, or 5.0 inches along the sidewall 508. In some embodiments, the guide tab 312 can extend about 0.1, 0.2, 0.3, 0.4, 0.5, 0.6, 0.7, 0.8, 0.9, or 1.0 feet along the sidewall 508. In some embodiments, the guide tab 312 can extend less than about 0.1, 0.2, 0.3, 0.4, 0.5, 0.6, 0.7, 0.8, 0.9, or 1.0 feet along the sidewall 508. In some embodiments, multiple guide tabs 312 or locking tabs 308 can be on each sidewall 508.

Disclosed is a configuration of a female attachment means, but the means does not limit the disclosure and any general type of female attachment means known in the art can be used.

While the above disclosure describes specific male and female attachment portions, they do not limit the disclosure. Any type of male and female attachment means can be used and can have advantageous qualities. In some embodiments, different types of female attachment means can be used between the top 502 and the double-sided female connector 302. In some embodiments, different types of male attachment means can be used between the container 202 and the double-sided male connector 402. In some embodiments, the double-sided male and female connectors 302/402 can have different male and female attachment portions 210/306 on opposite sides.

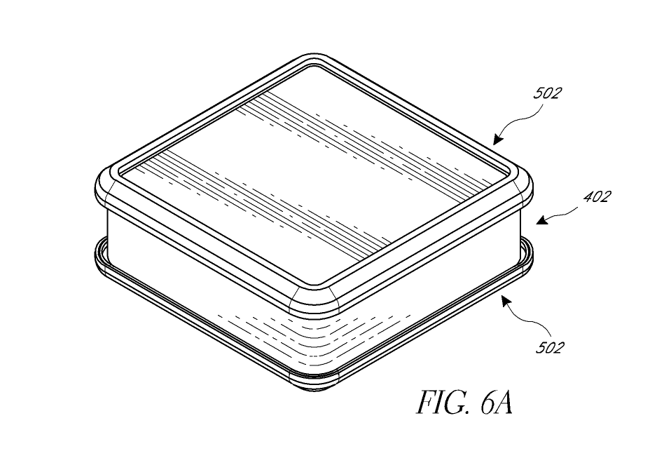

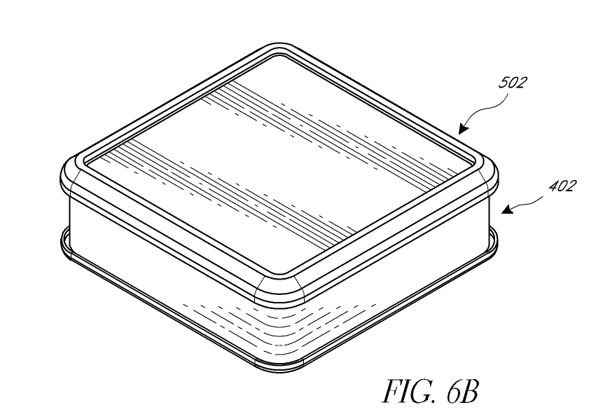

FIGS. 6-9 illustrate different example configurations of embodiments of a modular storage system 100. However, the described configurations do not limit the disclosure and any number of configurations using the above described components 102 can be used.

FIGS. 6A-B illustrates an example configuration of a modular storage system 100. As shown in FIG. 6A, the modular storage system 100 can be made up of two lids 502 sandwiching a double-sided male connector 402. In some embodiments, the lids 502 can have male attachment portions and can sandwich a double-sided female connector 302. As shown in FIG. 6B, the modular storage system 100 can be made up of just one lid 502 attached to a double-sided male connector 402. In some embodiments, the lids 502 can have male attachment portions and can be attached to a double-sided female connector 302.

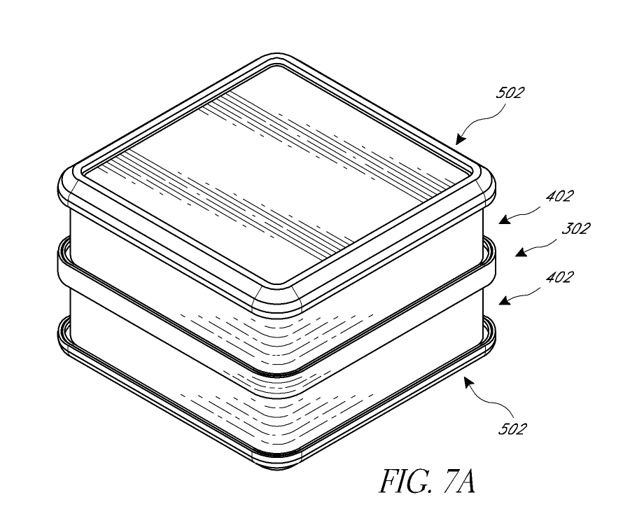

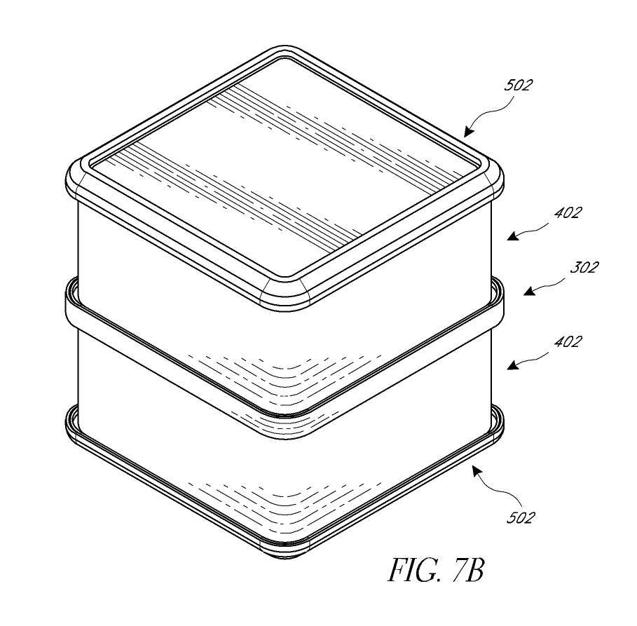

FIG. 7A illustrates another example configuration of a modular storage system 100. As shown, the modular storage system 100 can have two lids 502 on each end. Each lid 502 can be connected to a double-sided male connector 402. The two double-sided male connectors 402 can then be connected to one another by a double-sided female connector 302. In some embodiments, the connectors can be reversed. FIG. 7B illustrates a similar configuration of a modular storage system 100. However, as shown the double-sided male connector 402 is substantially thicker than the double-sided male connector 402 shown in FIG. 7A.

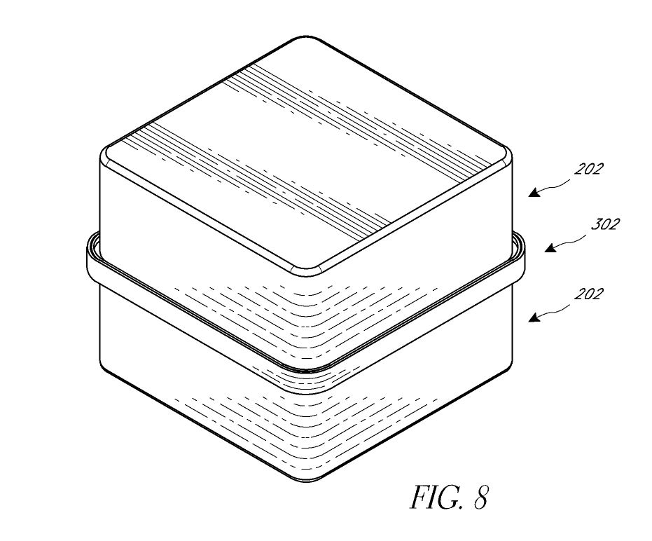

FIG. 8 illustrates an example configuration of a modular storage system 100. As shown, the modular storage system 100 can be made up of two containers 202 sandwiching a double-sided female connector 302. In some embodiments, the containers 202 can have male attachment portions and can sandwich a double-sided female connector 302. FIG. 8B illustrates a similar configuration of a modular storage system 100.

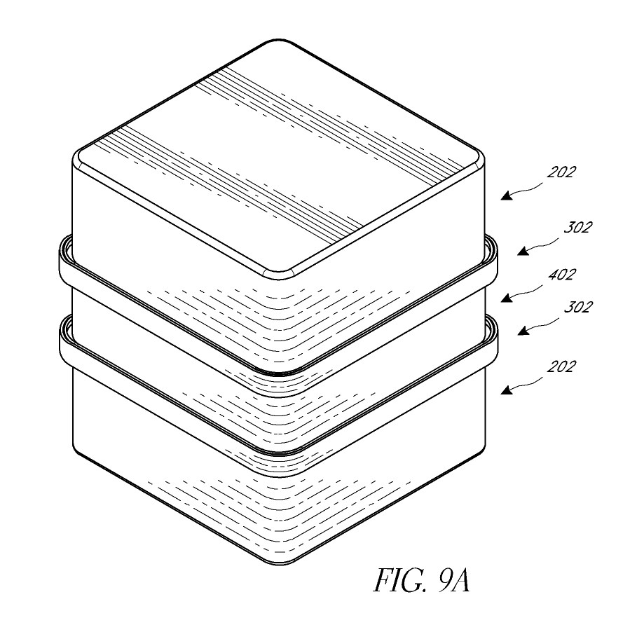

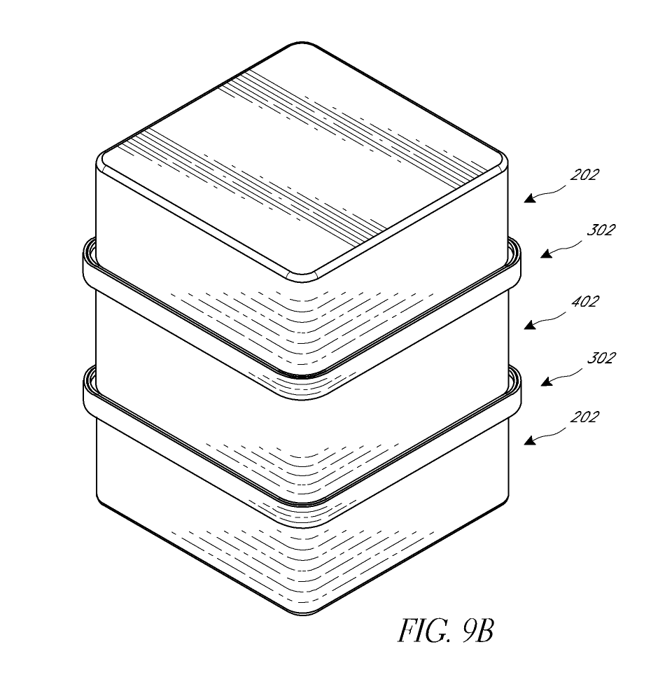

FIG. 9A illustrates another example configuration of a modular storage system 100. As shown, the modular storage system 100 can have two containers 202 on each end. Container 202 can be connected to a double-sided female connector 302. The two double-sided female connectors 302 can then be connected to one another by a double-sided male connector 402. In some embodiments, the connectors can be reversed. FIG. 9B illustrates a similar configuration of a modular storage system 100. However, as shown the female and male connectors 302/402 are substantially thicker than the female and male connector 302/402 shown in FIG. 9A.

Any number of combinations of lids, containers, and connectors can be used to form a modular storage system 100 of a desired size and/or shape. Components 102 (e.g. 202, 302, 402, and 502) can be added or removed to adjust the size of the system 100 so that the system 100 can be moved and relocated to different sized areas. Further, other types of releasable connections and connectors can be used, and do not limit the disclosure.

In addition to providing flexibility in sizing, the embodiments of the modular storage system 100 described herein present the advantage of providing access to a modular container at various positions within the container. As described above, each of the components 102 is releasably connected to the component 102 next to it. Therefore, a user can open the modular storage system 100 at any connection point along the structure. This can be advantageous if the modular storage system 100 contains a substance that reduces in volume through use, for example cereal or dog food. A user can access the top level of the substance at whichever juncture between components 102 is above the top level. A user can simply disconnect the components 102 at that juncture to access the substance. Organization through storage containment is desirably redefined due to the storage system's resizability (desirably provided by the CUFF brand second connector and LINK brand first connector) which allows for adaptability and customization to changing conditions. This desirably creates a new dimension to usability and reusability of containers and supports longevity of product use and attempts to avoid waste due to restricted sizing making the system environmentally friendly.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount.

Some embodiments have been described in connection with the accompanying drawings. The figures are drawn to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims.

What is claimed is:

1. A modular storage system, said storage system comprising:
a container comprising an outer wall that defines an interior space, a bottom wall connected to the outer wall, and an upper rim that defines a perimeter of an open top, the upper rim having at least one first engagement element;
a first connector comprising an outer wall that defines an interior space, a lower rim that defines a perimeter of an open bottom, and an upper rim that defines a perimeter of an open top, both the lower rim and upper rim having at least one second engagement element;
a second connector comprising an outer wall that defines an interior space, a lower rim that defines a perimeter of an open bottom, and an upper rim that defines a perimeter of an open top, both the lower rim and upper rim having at least one first engagement element;
a lid comprising a top wall and a lower rim, the lower rim having at least one second engagement element;
wherein at least one of the second engagement elements of the first connector is configured to releasably engage the first engagement element of the container and at least another of the second engagement elements of the first connector located on an opposite rim of the outer wall is configured to releasably engage the first engagement element of the second connector; and
wherein at least one of the first engagement elements of the second connector is configured to releasably engage the second engagement element of the lid and at least another of the first engagement elements of the second connector located on an opposite rim of the outer wall is configured to releasably engage the second engagement element of the first connector.

2. The system of claim 1, wherein the lid further comprises an outer wall connecting the top wall and the lower rim, the outer wall being shorter than the outer wall of the container.

3. The system of claim 1, wherein the first engagement elements are male engagement elements.

4. The system of claim 2, wherein the male engagement elements extend substantially around the perimeter.

5. The system of claim 1, wherein the second engagement elements are female engagement elements.

6. The system of claim 5, wherein the female engagement elements comprise a plurality of flexible tabs configured to releasably retain the first engagement elements.

7. The system of claim 1, further comprising third and fourth connectors, the third connector configured to have at least one first engagement element on each of a first rim and a second rim of the third connector, and the fourth connector configured to have at least one second engagement element on each of a first rim and a second rim of the fourth connector.

8. The system of claim 7, the third and fourth connectors configured to releasably be inserted between the container and lid of the storage system.

9. The system of claim 1, wherein the system is at least 2 feet tall.

10. The system of claim 1, wherein all connections between the container, connectors, and lid are fluid tight seals.

11. The system of claim 1, wherein the first and second engagement elements are configured to be generally engaged along an axis perpendicular to a plane formed by their associated rims.

12. A connector piece for use in a modular storage system, said piece comprising:
a plurality of connected sidewalls defining a perimeter of the piece, the plurality of sidewalls having an upper rim and lower rim;
the upper rim defining a first opening and the lower rim defining a second opening, the first and second opening being connected; and
at least one of a male engagement element and a female engagement element on the upper rim and the at least one of the male engagement element and the female engagement element on the lower rim, the engagement elements configured to releasably engage with the other of one of a male engagement element or a female engagement element.

13. The connector piece of claim 12, wherein the perimeter is generally square shaped.

14. The connector piece of claim 13, wherein the engagement elements are located on opposite walls of the connector piece on both the upper and lower rims.

15. The connector piece of claim 13, wherein the engagement elements are located each wall of the connector piece on both the upper and lower rims.

16. The connector piece of claim 12, wherein the at least one of a male engagement element or a female engagement element is a female engagement element.

17. The connector piece of claim 12, wherein the at least one of a male engagement element or a female engagement element is a male engagement element.

18. The connector piece of claim 12, wherein the connector piece the distance of the connector piece is at least one foot from the upper rim to the lower rim.

19. A lid component for use in a modular storage system, said lid comprising:
a lower perimeter and a top portion located opposite the lower perimeter and connected with at least one wall to form a closed top;
the lower perimeter defining a first opening, wherein the opening extends to the top portion and the at least one wall;
at least one female engagement element on the lower perimeter, wherein the at least one female engagement element is configured to releasably engage a male engagement element of a male connector piece, the male connector piece comprising:
a plurality of connected walls defining a perimeter of the engagement element, the plurality of walls having an upper rim and lower rim;
the upper rim defining a first opening and the lower rim defining a second opening, the first and second opening being connected;
at least one male engagement element on both the upper rim and the lower rim, the male engagement elements configured to releasably engage with the female engagement element of lid on one side, and another female engagement element on the opposite side.

20. The lid of claim 19, wherein the perimeter is generally square shaped.

21. A display for a modular household storage system, said display comprising:
a bottom portion comprising an outer wall that defines an interior space, a bottom wall connected to the outer wall, and an upper rim that defines a perimeter of an open top, the upper rim having at least one first engagement element;
a double-sided first engagement piece comprising an outer wall that defines an interior space, a lower rim that defines a perimeter of an open bottom, and an upper rim that defines a perimeter of an open top, both the lower rim and upper rim having at least one second engagement element;
a double-sided second engagement piece comprising an outer wall that defines an interior space, a lower rim that defines a perimeter of an open bottom, and an upper rim that defines a perimeter of an open top, both the lower rim and upper rim having at least one first engagement element;
a top portion comprising a top wall and a lower rim, the lower rim having at least one second engagement element;
wherein at least one of the second engagement elements of the double-sided first engagement piece is configured to releasably engage the first engagement element of the bottom portion, and at least another of the second engagement elements of the double-sided first engagement piece located on an opposite side of the outer wall is configured to releasably engage the first engagement element of the double-sided second engagement piece; and
wherein at least one of the first engagement elements of the double-sided second engagement piece is configured to releasably engage the second engagement element of top portion, and at least another of the first engagement elements of the double-sided second engagement piece located on an opposite side of the outer wall is configured to releasably engage the second engagement element of the double-sided first engagement piece.

22. The display of claim 21, wherein each of the top portion, bottom portion, double-sided second engagement piece, and double-sided first engagement piece is located in at least one bin.

23. The display of claim 21, wherein at least two of the top portion, bottom portion, double-sided second engagement piece, and double-sided first engagement piece are located in a same bin.

24. A variable sized storage container, said variable sized storage container comprising:
a bottom component having a bottom component storage area, the bottom component comprising one of a male or female engagement element;
a top component, the top component comprising another of the male or female engagement element opposite of the bottom component;
a container extension component disposed between the top component and the bottom component and defining an open top and an open bottom with a container extension storage area in between, the container extension component configured to releasably attach to the at least one male or female engagement element of the bottom component on one side and the another of the male or female engagement element of the top component on an opposite side of the container extension;
wherein the container extension storage area connects with the bottom component storage area, thereby increasing a storage capacity of the variable sized storage container.

25. The variable sized storage container of claim 24, wherein the container extension comprises a plurality of extension components, each extension component having a male or female engagement element on opposite ends of the extension component and a component storage area, wherein each extension component has either male engagement elements or female engagement elements.

26. The variable sized storage container of claim 25, wherein the container extension comprises an even number of extension components.
